(19) United States
(12) Patent Application Publication
(10) Pub. No.: US 2025/0306826 A1
(43) Pub. Date: Oct. 2, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Maki TAGUCHI, Kanagawa (JP)

(73) Assignee: FUJIFILM Business Innovation Corp., Tokyo (JP)

(21) Appl. No.: 18/775,695

(22) Filed: Jul. 17, 2024

(30) Foreign Application Priority Data
Mar. 27, 2024 (JP) 2024-051704

(51) Int. Cl. G06F 3/12

(52) U.S. Cl. CPC G06F 3/1261; G06F 3/1205

(57) ABSTRACT

An information processing system includes one or more processors configured to: acquire a setting value of one or more setting items and a setting condition under which one or more information processing apparatuses are capable of processing; and output an information processing apparatus that is capable of processing under a setting condition approximate to the setting value.

### CROSS-REFERENCE TO RELATED APPLICATIONS

This application is based on and claims priority under 35 USC 119 from Japanese Patent Application No. 2024-051704 filed Mar. 27, 2024.

### BACKGROUND

### (i) Technical Field

The present disclosure relates to an information processing system, an information processing method, and a non-transitory computer readable medium.

### (ii) Related Art

Japanese Unexamined Patent Application Publication No. 2001-350681 describes an image processing apparatus that stores information on functions of an apparatus and each image processing apparatus obtained from each image processing apparatus connected to a network as device data, displays information on functions executable by the image processing apparatus set as an output destination by an output-destination designating dialog on an operation screen with respect to each function obtained from a logical sum of all device data, and performs display control explicitly indicating with hatching or the like that inexecutable information cannot be executed.

Japanese Unexamined Patent Application Publication No. 2005-103962 describes a printer including a print control unit, in which when print data stored in a file server is detected, the print data and printing condition information corresponding to the print data are acquired from the file server, and the print control unit determines whether or not printing can be performed based on the acquired printing condition information, and performs control in such a manner that printing is performed based on the print data corresponding to the printing condition information when it is determined that printing can be performed, and that printing is not performed when it is determined that printing cannot be performed.

Japanese Unexamined Patent Application Publication No. 2013-091265 describes an image forming apparatus including a print control unit, in which an executable printing mode according to the type of consumables being attached is specified, in a case where an inquiry about whether or not printing can be performed under specified printing conditions is received from a host device, the print control unit checks the printing conditions against the executable printing mode and responds whether or not printing can be performed, and in a case where print data is received from the host device, the print control unit checks the instructed printing conditions against the executable printing mode and thereby instructs an image forming unit to perform printing when determining that printing can be performed, and responds that printing cannot be performed when determining that printing cannot be performed.

Japanese Unexamined Patent Application Publication No. 2019-1040 describes an image forming apparatus, in which when print data includes a page on which print processing cannot be executed with print settings specified for print data including multiple pages, a controller receives a change in print settings for each page, changes the print settings for the unprintable page to the received print settings to generate image data in a raster format, and controls an output unit based on the generated image data to execute print processing.

### SUMMARY

There is a case where a setting value of one or more setting items is specified without determining which information processing apparatus among one or more information processing apparatuses performs processing. In such a case, it has not been easy for a user to recognize, among one or more information processing apparatuses, an information processing apparatus that is capable of processing under a setting condition approximate to the setting value.

Aspects of non-limiting embodiments of the present disclosure relate to enabling a user to easily recognize an information processing apparatus that is capable of processing under a setting condition approximate to a setting value of one or more setting items, among one or more information processing apparatuses.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: acquire a setting value of one or more setting items and a setting condition under which one or more information processing apparatuses are capable of processing; and output an information processing apparatus that is capable of processing under a setting condition approximate to the setting value.

### BRIEF DESCRIPTION OF THE DRAWINGS

Exemplary embodiments of the present disclosure will be described in detail based on the following figures, wherein:

FIG. 1 is a diagram illustrating an example of the overall configuration of a printing system according to the present exemplary embodiment;

FIG. 2 is a diagram illustrating a hardware configuration example of a cloud server according to the present exemplary embodiment;

FIG. 3 is a diagram illustrating a hardware configuration example of a printer according to the present exemplary embodiment;

FIG. 4 is a diagram illustrating an example of a print setting screen displayed by a terminal apparatus;

FIG. 5 is a table illustrating an example of apparatus information stored in a cloud server;

FIG. 6 is a table illustrating an example of function information stored in the cloud server;

FIG. 7 is a diagram illustrating an example of a list information screen displayed by the terminal apparatus;

FIG. 8 is a diagram illustrating an example of a function information editing screen displayed by the terminal apparatus;

FIG. 9 is a block diagram illustrating a functional configuration example of the cloud server according to the present exemplary embodiment;

FIG. 10 is a flowchart illustrating an operation example of the cloud server according to the present exemplary embodiment;

FIG. 11A is a flowchart illustrating an example of detailed content of list information generation processing;

FIG. 11B is a flowchart illustrating an example of detailed content of list information generation processing; and

FIG. 11C is a flowchart illustrating an example of detailed content of list information generation processing.

### DETAILED DESCRIPTION

In the following, exemplary embodiments of the present invention will be described in detail with reference to the accompanying drawings.

### Outline of the Present Exemplary Embodiment

The present exemplary embodiment provides an information processing system that acquires a setting value of one or more setting items and a setting condition under which one or more information processing apparatuses are capable of processing, and outputs an information processing apparatus that is capable of processing under a setting condition approximate to the setting value.

Here, the “system” may be configured by a single apparatus, or may be configured by a plurality of apparatuses. In the following, an information processing system configured by a single apparatus will be described as an example, and a cloud server will be described as an example of the single apparatus.

In addition, the setting value of the setting item may be a setting value of a setting item in any processing, but hereinafter, a setting value of a function which is a setting item in a print processing will be described as an example.

Furthermore, the information processing apparatus may be an apparatus that performs any processing, but hereinafter, a printer that performs print processing will be described as an example. Although the setting condition may be setting conditions in any processing, the setting condition in print processing will be described as an example.

Note that in this specification and drawings, the setting value and the setting condition for such setting items are sometimes referred to as “print settings”.

### Overall Configuration of Printing System

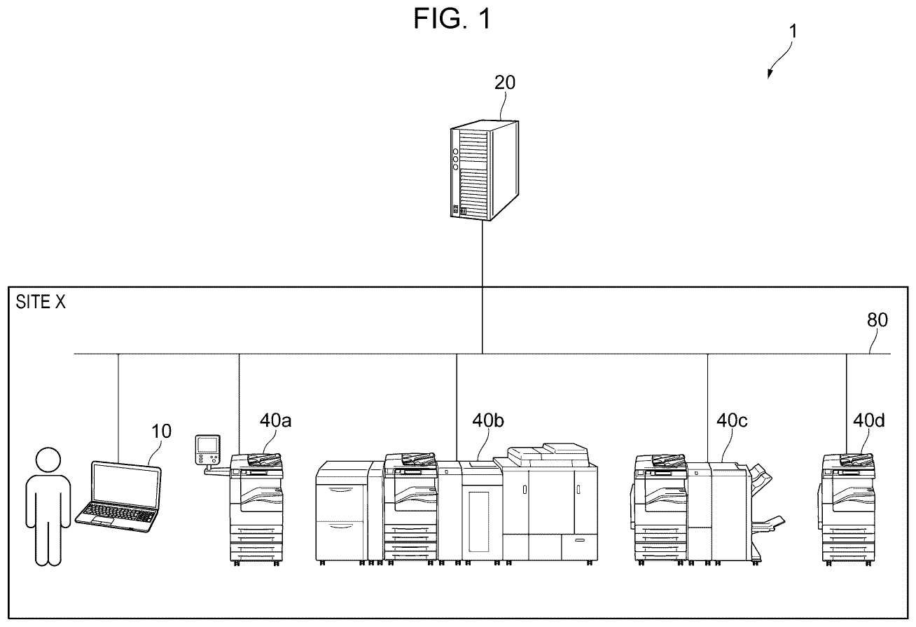

FIG. 1 is a diagram illustrating an example of the overall configuration of a printing system 1 according to the present exemplary embodiment. As illustrated, the printing system 1 includes a terminal apparatus 10, a cloud server 20, and printers 40a to 40d. The terminal apparatus 10 and the printers 40a to 40d are connected to the cloud server 20 via a communication network 80. Note that although the printers 40a to 40d are illustrated in the figure, they may be referred to as a printer 40 when there is no need to distinguish between them. In addition, although only the terminal apparatus 10 and the printer 40 at a site X are illustrated in the figure, the terminal apparatus 10 and the printer 40 at another site may be connected to the cloud server 20.

The terminal apparatus 10 is a computer used by a user. The terminal apparatus 10 generates print data to be printed by any of the printers 40 and transmits a print instruction for the print data to the cloud server 20. It is assumed that a common printer driver capable of specifying all of the functions available on at least one printer 40 at, for example, the site X is installed in the terminal apparatus 10. As the terminal apparatus 10, for example, a desktop PC, a notebook PC, a portable information terminal, or the like may be used. Note that in the figure, only one terminal apparatus 10 is illustrated at the site X, but a plurality of terminal apparatuses 10 may be provided at the site X.

The cloud server 20 is a server computer that provides a cloud service that enables a user to log in to any one of the printers 40 and print print data after the user gives an instruction to print the print data. Although only one cloud server 20 is illustrated in the figure, a plurality of cloud servers 20 may be provided. Further, a normal server computer may be used instead of the cloud server 20.

The printer 40 is an apparatus to print information on a recording medium such as paper. The printer 40 acquires and prints the print data by instructing the cloud server 20 to output the print data. Note that although only four printers 40 are illustrated at the site X in the figure, five or more printers 40 may be provided at the site X.

The communication network 80 is a network used for information communication between the terminal apparatus 10 and the cloud server 20 and between the printer 40 and the cloud server 20. As the communication network 80, for example, the Internet or a local area network (LAN) may be used.

### Hardware Configuration of Cloud Server

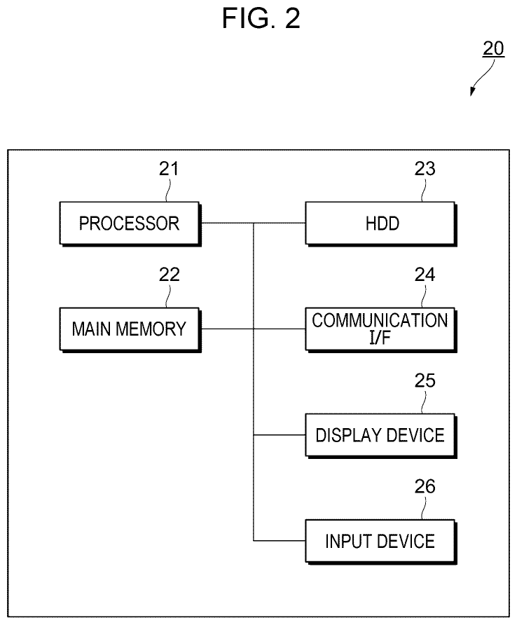

FIG. 2 is a diagram illustrating a hardware configuration example of the cloud server 20 according to the present exemplary embodiment. As illustrated, the cloud server 20 includes a processor 21, a main memory 22, a hard disk drive (HDD) 23, a communication interface (hereinafter, referred to as a “communication I/F”) 24, a display device 25, and an input device 26.

The processor 21 executes various types of software, such as an operating system (OS) and applications, and implements functions described later.

The main memory 22 is a memory used as a working memory or the like of the processor 21.

The HDD 23 is, for example, a magnetic disk device that stores input data for various kinds of software, output data from various kinds of software, and the like.

The communication I/F 24 transmits and receives various kinds of information to and from the terminal apparatus 10 and transmits and receives various kinds of information to and from the printer 40 via the communication network 80.

The display device 25 is, for example, a display that displays various kinds of information.

The input device 26 is, for example, a keyboard or a mouse used by a user to input information.

In addition, the hardware configuration illustrated in FIG. 2 may also be considered as a hardware configuration of the terminal apparatus 10. Provided that when the terminal apparatus 10 is described, the processor 21, the main memory 22, the HDD 23, the communication I/F 24, the display device 25, and the input device 26 in FIG. 2 are referred to as a processor 11, a main memory 12, an HDD 13, a communication I/F 14, a display device 15, and an input device 16, respectively.

### Hardware Configuration of Printer

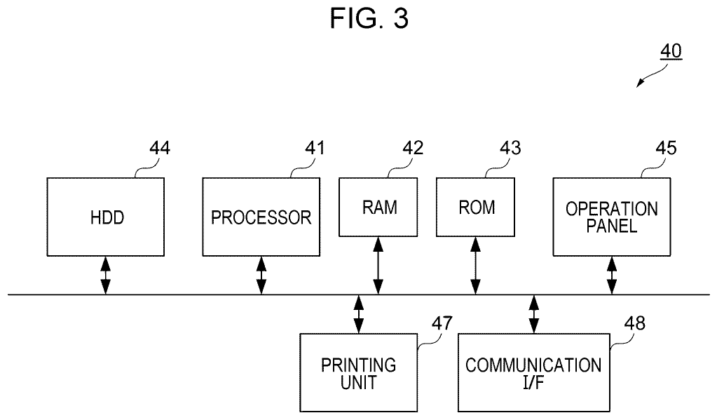

FIG. 3 is a diagram illustrating a hardware configuration example of the printer 40 according to the present exemplary embodiment. As illustrated, the printer 40 includes a processor 41, a random access memory (RAM) 42, a read only memory (ROM) 43, an HDD 44, an operation panel 45, a printing unit 47, and a communication I/F 48.

The processor 41 loads various programs stored in the ROM 43 or the like into the RAM 42 and executes the programs to implement functions described later.

The RAM 42 is a memory used as a working memory or the like of the processor 41.

The ROM 43 is a memory that stores various programs and the like executed by the processor 41.

The HDD 44 is, for example, a magnetic disk device that stores print data and the like used in print processing in the printing unit 47.

The operation panel 45 is, for example, a touch panel that displays various kinds of information and receives operation input from a user. Here, the operation panel 45 includes a display on which various kinds of information are displayed and a position detection sheet for detecting a position pointed by a pointing tool such as a finger or a stylus pen. Alternatively, a display and a keyboard may be used instead of the touch panel.

The printing unit 47 prints information on a recording medium such as paper. Here, the printing unit 47 is a printer, for example, and it is preferable to use an electrophotographic method in which a toner adhered to a photoreceptor is transferred onto a recording medium to form an image, or an inkjet method in which ink is discharged onto a recording medium to form an image.

The communication I/F 48 transmits and receives various kinds of information to and from the cloud server 20 via the communication network 80.

### Problems and Solution of Printing System

In the printing system 1 as described above, in many cases, the user does not clearly understand the functions of each installed printer 40.

Therefore, in a case where there is no printer 40 that can perform output as per the print settings, the user does not know that the output cannot be performed as per the print settings until the output is actually performed.

Further, in a case where the output cannot be performed as per the print settings, the user does not know the unavailable function, and thus does not know which print setting should be changed.

As such, in the printing system 1 of the present exemplary embodiment, it is possible to search for the printer 40 having a similar function, and to change some print settings for output.

Further, when there is a print setting that the user does not want to change, it is difficult for the user to know which printer 40 will produce acceptable output for the user.

Therefore, in the printing system 1 of the present exemplary embodiment, the essential function and priority of the function are designated in advance, thereby searching for the printer 40 that can perform output and displaying a list based on the designation.

### Specific Example of Operation of Printing System

In the printing system 1 according to the present exemplary embodiment, first, the terminal apparatus 10 transmits to the cloud server 20 a print instruction in which a setting value for a function instructed by a user (hereinafter, referred to as an “instruction setting value”) is specified. Here, a case where a setting value “color” for the function “color/monochrome”, a setting value “four positions” for the function “staple”, a setting value “two holes” for the function “punch”, and a setting value “Z fold” for the function “fold” are specified as the instruction setting values, is described as an example. Note that these functions are merely examples, and setting values for other functions may be specified.

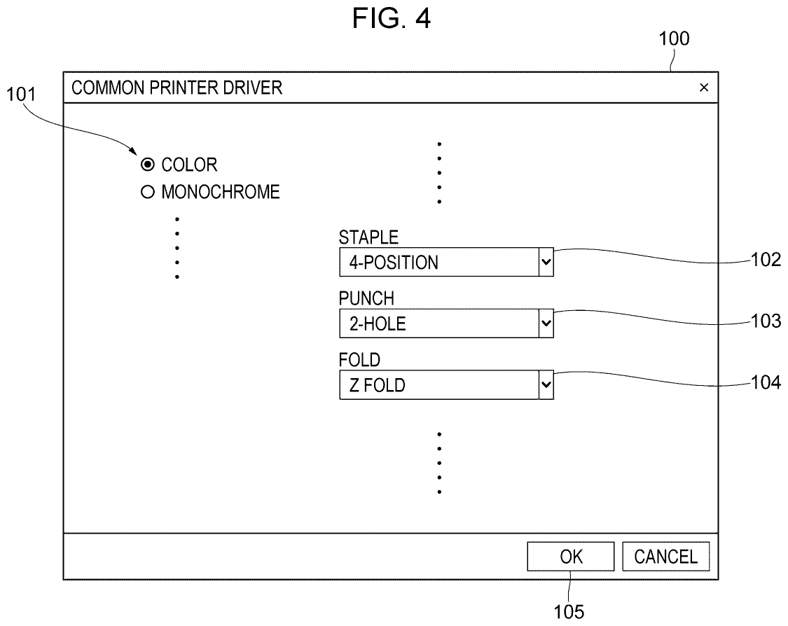

FIG. 4 is a diagram illustrating an example of a print setting screen 100 displayed on the display device 15 by the terminal apparatus 10 in order to specify these instruction setting values. As illustrated, in the print setting screen 100, “color” is set in a “color/monochrome” setting field 101, “four positions” is set in a “staple” setting field 102, “two holes” is set in a “punch” setting field 103, and “Z fold” is set in a “fold” setting field 104.

Normally, when an OK button 105 is pressed on the print setting screen 100, the terminal apparatus 10 transmits a print instruction to the cloud server 20, and the print instruction is completed. On the other hand, in the present exemplary embodiment, when the OK button 105 is pressed on the print setting screen 100, the cloud server 20 searches for a printer that can perform output as per the instruction setting value. Then, in a case where there is no printer that can perform output as per the instruction setting value, the cloud server 20 searches for a printer that can perform output by changing to the setting value close to the instruction setting value.

As such, the cloud server 20 stores apparatus information including information on the location where the printer 40 is installed and information on the setting value that can be set for the printer 40 (hereinafter, referred to as an “apparatus setting value”).

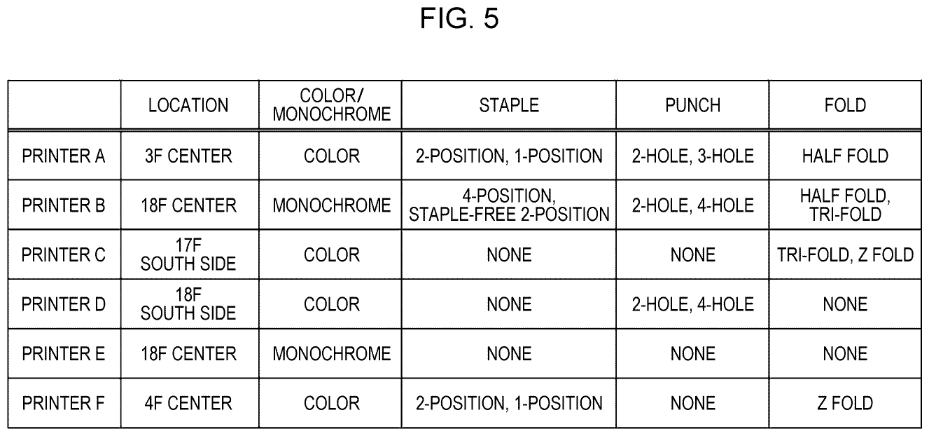

FIG. 5 is a table illustrating an example of such apparatus information.

As illustrated, the apparatus information indicates, in the “location” field, the location where printers A to F are each installed.

Furthermore, in the apparatus information, the setting value of each function that can be set for the respective printers A to F is indicated in the “color/monochrome” field, the “staple” field, the “punch” field, and the “fold” field, which correspond to the functions.

Note that here, the printers A to F are shown as the printer 40, but this is merely an example. Other printers may be used as the printer 40.

In addition, the cloud server 20 also stores function information including information on priorities of a plurality of functions and information on closeness between setting values of each function.

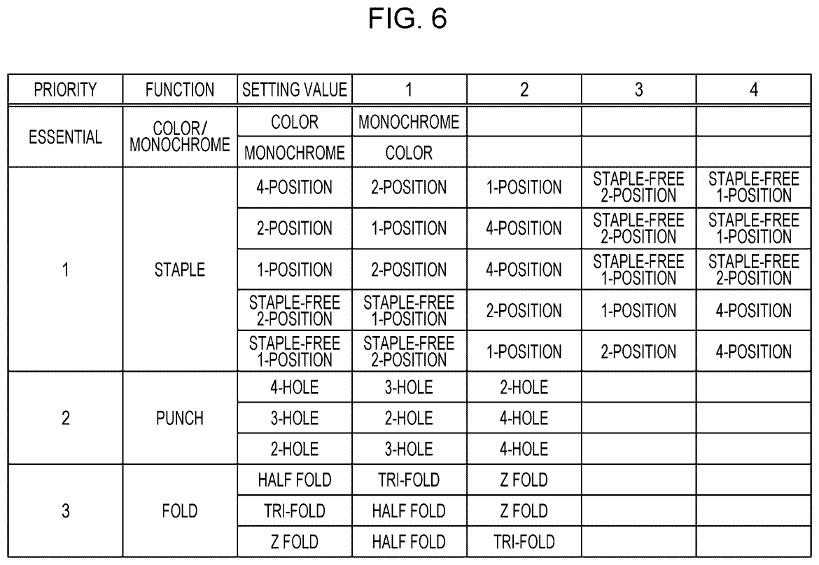

FIG. 6 is a table illustrating an example of such function information.

As illustrated, in the function information, “essential”, “1”, “2”, and “3” are shown in the “priority” field. A function, the priority of which is “essential”, is a function for which the instruction setting value is desired to be maintained as much as possible when searching for a printer with the apparatus setting value close to the instruction setting value. A function, the priority of which is not “essential”, is a function for which it is not necessary to maintain the instruction setting value when searching for a printer with the apparatus setting value close to the instruction setting value, and these functions are assigned priorities of “1”, “2”, and “3” in the order in which the instruction setting value is desired to be maintained. Note that although the priorities are assigned “1”, “2”, and “3” here, the number of priorities is not limited to this. As the priority, a rank of a number greater than “3” may be set. In addition, here, one function the priority of which is “essential” is given, but two or more functions the priority of which is “essential” may be given, and the priorities “1”, “2”, “3”, . . . may be set.

Further, in the function information, for the instruction setting value in the “setting value” field, when the instruction setting value cannot be set, a setting value that can be set is shown as an alternative (hereinafter referred to as an “alternative setting value”) in the “1”, “2”, “3”, and “4” fields. Here, “1”, “2”, “3”, and “4” indicate alternative ranks that are ranks when the instruction setting value is replaced by the alternative setting value.

In such a state, the cloud server 20 focuses on the functions in the order of the priorities “essential”, “1”, “2”, and “3”.

First, the cloud server 20 focuses on the function “color/monochrome” the priority of which is “essential”. Then, the cloud server 20 determines, with reference to the apparatus information in FIG. 5, that the printer 40 in which the instruction setting value “color” can be set is the printers A, C, D, and F. On the other hand, the cloud server 20 determines, with reference to the apparatus information in FIG. 5, that the printer 40 in which the instruction setting value “color” cannot be set is the printers B and E. Thus, the cloud server 20 determines the candidate ranks of the printers A, C, D, and F as 1 to 4 and the candidate ranks of the printers B and E as 5 and 6.

In addition, the cloud server 20 targets the printers A, C, D, and F, and focuses on the function “staple” the priority of which is “1”. Then, the cloud server 20 refers to the apparatus information in FIG. 5, and determines that there is no printer 40 in which the instruction setting value “four positions” can be set. In addition, the cloud server 20 refers to the function information of FIG. 6, acquires the alternative setting value “two positions” with respect to the instruction setting value “four positions”, and determines that the printer 40 in which this alternative setting value “two positions” can be set is the printers A and F. On the other hand, the cloud server 20 refers to the apparatus information in FIG. 5, and determines that the printer 40 in which neither the instruction setting value “four positions” nor the alternative setting value can be set are the printers C and D. As a result, the cloud server 20 determines the candidate ranks of the printers A and F as 1 and 2, and the candidate ranks of the printers C and D as 3 and 4.

Furthermore, the cloud server 20 targets the printers A and F and focuses on the function “punch” the priority of which is “2”. Then, the cloud server 20 refers to the apparatus information in FIG. 5, and determines that the printer 40 in which the instruction setting value “two holes” can be set is the printer A. On the other hand, the cloud server 20 refers to the apparatus information in FIG. 5, and determines that the printer 40 in which neither the instruction setting value “two holes” nor the alternative setting value can be set is the printer F. As a result, the cloud server 20 determines the candidate rank of the printer A as 1 and the candidate rank of the printer F as 2.

Further, the cloud server 20 targets the printers C and D and focuses on the function “punch” the priority of which is “2”. Then, the cloud server 20 refers to the apparatus information in FIG. 5, and determines that the printer 40 in which the instruction setting value “two holes” can be set is the printer D. On the other hand, the cloud server 20 refers to the apparatus information in FIG. 5, and determines that the printer 40 in which neither the instruction setting value “two holes” nor the alternative setting value can be set is the printer C. As a result, the cloud server 20 determines the candidate rank of the printer D as 3 and the candidate rank of the printer C as 4.

In addition, the cloud server 20 targets the printers B and E and focuses on the function “staple” the priority of which is “1”. Then, the cloud server 20 refers to the apparatus information in FIG. 5, and determines that the printer 40 in which the instruction setting value “four positions” can be set is the printer B. On the other hand, the cloud server 20 refers to the apparatus information in FIG. 5 and determines that the printer 40 in which neither the instruction setting value “four positions” nor the alternative setting value can be set is the printer E. As a result, the cloud server 20 determines the candidate rank of the printer B as 5, and the candidate rank of the printer E as 6.

Thereafter, the cloud server 20 generates list information in which the plurality of printers 40 is arranged in the candidate ranking and transmits the list information to the terminal apparatus 10, and the terminal apparatus 10 displays the list information on the display device 15.

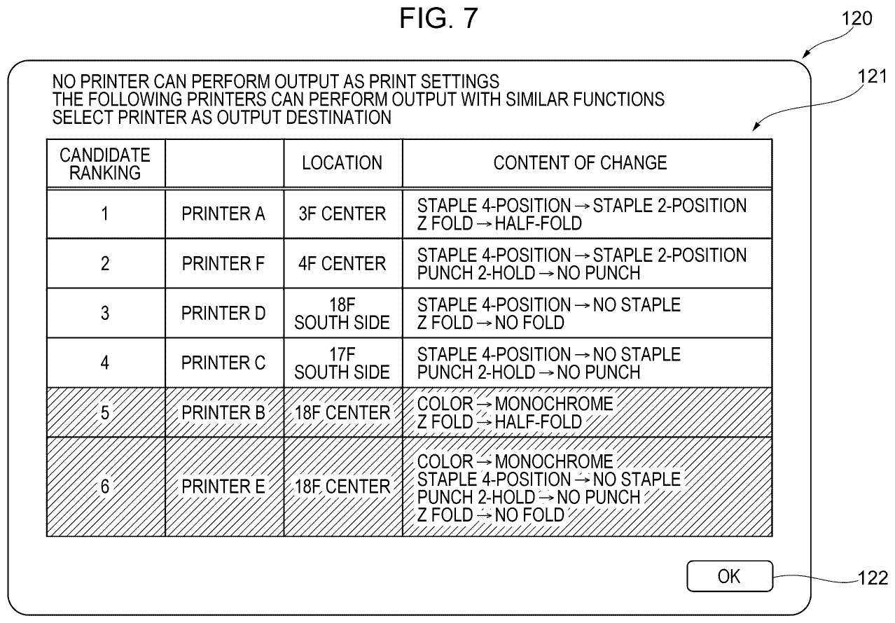

FIG. 7 is a diagram illustrating an example of a list information screen 120 displayed on the display device 15 by the terminal apparatus 10.

As illustrated, on the list information screen 120, a piece of list information 121 includes the candidate rank for each of the plurality of printers 40.

In addition, on the list information screen 120, the list information 121 also includes, for each of the plurality of printers 40, the content of the change to the instruction setting value required when printing is performed by the printer 40.

Further, on the list information screen 120, the list information 121 also includes, for each of the plurality of printers 40, information on the location where the printer 40 is installed.

The user completes the print instruction by selecting the printer 40 as an output destination from the plurality of printers 40 included in the list information 121 and pressing an OK button 122. Then, the cloud server 20 changes the instruction setting value in accordance with the content of the change to the selected printer 40, and stores the changed instruction setting value and the print data. Then, the user moves to the front of the printer 40 as the selected output destination, and gives output instruction of the print data from the printer 40.

Note that in the list information 121, the plurality of printers 40 may be arranged in ascending order of closeness of the installation location based on the user's current position information or the user's pre-registered position information. Alternatively, in the list information 121, the installation locations of the plurality of printers 40 may be indicated by a map. When searching for the printer 40 in an environment in which all of the terminal apparatuses 10 and the printers 40 are connected via the cloud server 20, all of the printers 40 at a certain site are targeted, and therefore, a considerable number of printers 40 are included in the list information 121 at a large site. Even when the printer 40 that can perform output is determined among them, it is often unclear where the printer 40 is located, and therefore, the printer 40 can be easily selected by being displayed in the ascending order of closeness of the installation location of the printer 40. For example, a condition such as location within two floors above and below the floor on which the user is present may be included in the condition for determining the candidate ranking.

In addition, for the function “color/monochrome” the priority of which is “essential”, the printer 40 in which the instruction setting value “color” cannot be set is indicated by diagonal hatching in the figure, but it is not limited thereto. For the function “color/monochrome” the priority of which is “essential”, the printer 40 in which the instruction setting value “color” can be set and the printer 40 in which the instruction setting value “color” cannot be set may be distinguished by another display manner. Alternatively, for the function “color/monochrome” the priority of which is “essential”, the printer 40 in which the instruction setting value “color” cannot be set may not be displayed from the start.

In the present exemplary embodiment, by displaying the list information screen 120 in FIG. 7, even in a case where there is no printer 40 that can perform output as per the print settings, the setting items that need to be changed before output can be known. As a result, even a user who has difficulty in understanding the functions of each printer 40 can output print data with desired print settings as much as possible.

Furthermore, in the present exemplary embodiment, the user can change, add, and delete the function information in FIG. 6.

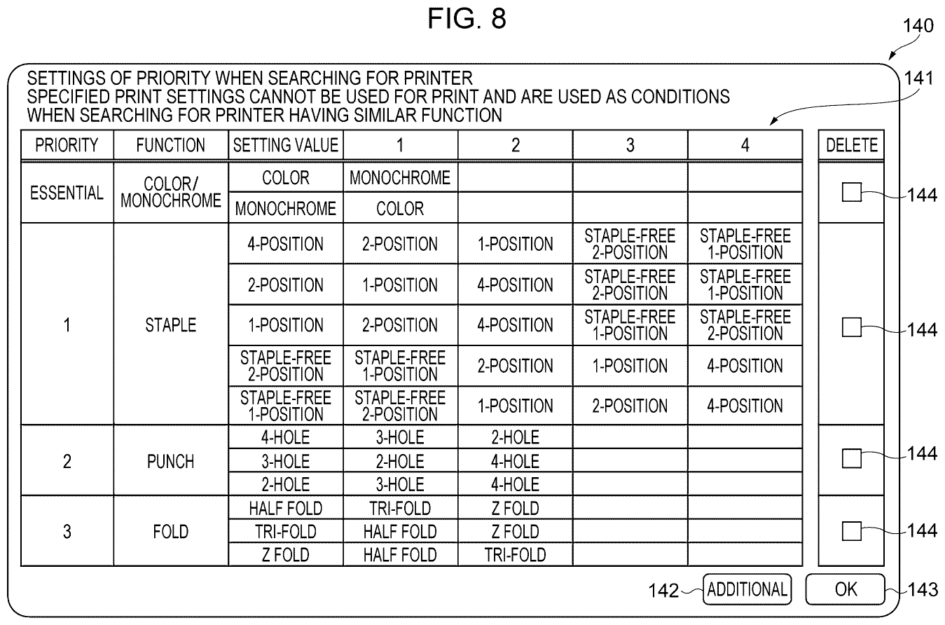

FIG. 8 is a diagram illustrating an example of a function information editing screen 140 displayed on the display device 15 by the terminal apparatus 10 in order to change, add, or delete the function information.

As illustrated, a piece of currently specified function information 141 is displayed on the function information editing screen 140.

When the user presses an add button 142 in this state, a new row for adding a function is additionally displayed for the function information 141. Then, when the user selects and inputs, in the new row, the name of the function in the “function” field, selects and inputs a plurality of setting values for the function in the “setting value” field, selects and inputs the alternative setting value for each setting value in the “1” field and the like, and presses an OK button 143, the addition of the function is confirmed.

In addition, when the user checks a delete check box 144 on the function information editing screen 140, the function corresponding to the delete check box 144 is deleted. When the user presses the OK button 143, the deletion of the function is confirmed.

Furthermore, on the function information editing screen 140, for example, the user may change letters in the function information 141 and press the OK button 143, thereby changing the information about the function.

### Functional Configuration of Cloud Server

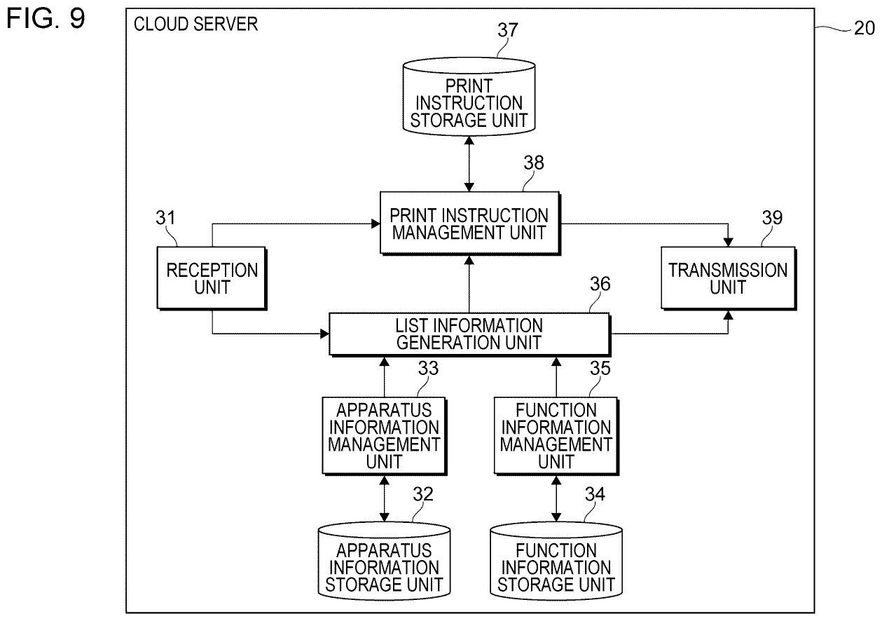

FIG. 9 is a block diagram illustrating a functional configuration example of the cloud server 20 according to the present exemplary embodiment. As illustrated, the cloud server 20 includes a reception unit 31, an apparatus information storage unit 32, an apparatus information management unit 33, a function information storage unit 34, a function information management unit 35, a list information generation unit 36, a print instruction storage unit 37, a print instruction management unit 38, and a transmission unit 39.

First, the reception unit 31 receives at least one instruction setting value specified by the print instruction from the terminal apparatus 10. Here, as described above, the instruction setting value is a setting value for a function in print processing. In the present exemplary embodiment, at least one instruction setting value is used as an example of the setting value of one or more setting items, and this processing of the reception unit 31 is performed as an example of acquiring the setting value.

In addition, after the user selects the printer 40 as the output destination, the reception unit 31 receives the print instruction of the print data including the selected printer 40 from the terminal apparatus 10.

Further, when the user moves to the front of the printer 40 of the output destination and gives an output instruction of the print data, the reception unit 31 receives the output instruction from the printer 40.

The apparatus information storage unit 32 stores apparatus information in which the printer 40, the location where the printer 40 is installed, and information on the apparatus setting value that can be set in the printer 40 are associated with each other. Here, the apparatus information is, for example, the information illustrated in FIG. 5.

The apparatus information management unit 33 reads the apparatus information from the apparatus information storage unit 32. For example, when the reception unit 31 receives the instruction setting value, the apparatus information management unit 33 reads the apparatus information stored in the apparatus information storage unit 32 in order to cause the list information generation unit 36 to generate the list information. In the present exemplary embodiment, the apparatus setting value is used as an example of the setting condition under which one or more information processing apparatuses are capable of processing, and this processing of the apparatus information management unit 33 is performed as an example of acquiring the setting condition.

In addition, the apparatus information management unit 33 writes the apparatus information in the apparatus information storage unit 32. For example, when the printer 40 constituting the printing system 1 is added or deleted, or the function of the printer 40 constituting the printing system 1 is changed, the apparatus information management unit 33 updates the apparatus information stored in the apparatus information storage unit 32.

The function information storage unit 34 stores function information in which the function, the priority of the function, the setting value of the function, and the alternative setting value for each setting value at each alternative rank of the function are associated with each other. Here, the function information is, for example, the information illustrated in FIG. 6.

The function information management unit 35 reads function information from the function information storage unit 34. For example, when the reception unit 31 receives the instruction setting value, the function information management unit 35 reads the function information stored in the function information storage unit 34 in order to cause the list information generation unit 36 to generate the list information. In the present exemplary embodiment, the alternative setting value is used as an example of an alternative setting value determined in advance for the setting value, and this processing of the function information management unit 35 is performed as an example of acquiring the alternative setting value. Further, in the present exemplary embodiment, this processing of the function information management unit 35 is performed as an example of further acquiring the alternative ranking of the alternative setting value determined in advance for the setting value.

In addition, the function information management unit 35 writes the function information in the function information storage unit 34. For example, when a user adds or deletes a function to be considered in searching for the printer 40 or changes the priority of such a function or the alternative setting value for each setting value, the function information management unit 35 updates the function information stored in the function information storage unit 34.

The list information generation unit 36 generates list information of the printer 40 based on the instruction setting value received by the reception unit 31, the apparatus information read by the apparatus information management unit 33, and the function information read by the function information management unit 35. Here, the list information of the printer 40 is information indicating how close the apparatus setting value of the printer 40 is to the instruction setting value instructed by the user. In the present exemplary embodiment, the list information of the printer 40 is used as an example of approximation information indicating how approximate a setting condition under which one or more information processing apparatuses are capable of processing is to the setting value.

Specifically, the list information generation unit 36 generates list information including the candidate rank of each of the plurality of printers 40. Here, the candidate rank of each of the plurality of printers 40 is a rank indicating how close the apparatus setting value set in the printer 40 is to the instruction setting value. In the present exemplary embodiment, the candidate ranking is used as an example of an approximation ranking, which is a ranking of each information processing apparatus among one or more information processing apparatuses and is a ranking related to how approximate the setting condition under which each information processing apparatus is capable of processing is to the setting value.

The list information generation unit 36 generates the candidate ranking in accordance with the following rules.

A first rule is a rule for generating the candidate ranking by focusing on one function. It is assumed that the apparatus setting value of a first printer 40 satisfies the instruction setting value of a specific function and the apparatus setting value of a second printer 40 does not satisfy the instruction setting value of the specific function. The first rule is that, in such a case, the candidate rank of the first printer 40 is set higher than the candidate rank of the second printer 40. Here, the priority of the specific function may be “essential” or may not be “essential”. Furthermore, the term “satisfy” may indicate that the apparatus setting value includes the instruction setting value when the priority of the specific function is “essential”, and may indicate that the apparatus setting value includes the instruction setting value or the alternative setting value for the instruction setting value when the priority of the specific function is not “essential”.

In the examples of FIG. 4 to FIG. 7, a case is considered where the first printer 40 is the printer A, the second printer 40 is the printer B, and the specific function is “color/monochrome”. In this case, the apparatus setting value “color” of the printer A includes the instruction setting value “color”, and the apparatus setting value “monochrome” of the printer B does not include the instruction setting value “color”. Therefore, the candidate rank of the printer A is higher than the candidate rank of the printer B.

Furthermore, in the examples of FIG. 4 to FIG. 7, a case is considered in which the first printer 40 is the printer A, the second printer 40 is the printer C, and the specific function is “staple”. In this case, the apparatus setting values “two positions, one position” of the printer A do not include the instruction setting value “four positions” but include the alternative setting value “two positions”, and the apparatus setting value “no (staple)” of the printer C includes neither the instruction setting value “four positions” nor the alternative setting value. Therefore, the candidate rank of the printer A is higher than the candidate rank of the printer C.

In the present exemplary embodiment, when a setting condition under which a first information processing apparatus is capable of processing satisfies a setting value of a specific setting item and a setting condition under which a second information processing apparatus is capable of processing does not satisfy the setting value of the specific setting item, the processing for generating the candidate ranking in accordance with the first rule is performed in a manner such that the approximation ranking of the first information processing apparatus is higher than the approximation ranking of the second information processing apparatus, as an example of generating the approximation ranking.

A second rule is a rule for focusing on a plurality of functions and generating the candidate ranking by using the priority of the plurality of functions. It is assumed that the apparatus setting values of both the first printer 40 and the second printer 40 satisfy or do not satisfy the instruction setting value of a first function. Then, it is assumed that the apparatus setting value of the first printer 40 satisfies the instruction setting value of a second function at a rank of the priority next to the first function, and the apparatus setting value of the second printer 40 does not satisfy the instruction setting value of the second function. The second rule is that, in such a case, the candidate rank of the first printer 40 is set higher than the candidate rank of the second printer 40. Here, the priority of the plurality of functions is not “essential” but may be “1”, “2”, “3”, or the like. Further, the term “satisfy” may mean that the apparatus setting value includes the instruction setting value or the alternative setting value for the instruction setting value.

In the examples of FIG. 4 to FIG. 7, a case is considered where the first printer 40 is the printer A, the second printer 40 is the printer F, the first function is “staple”, and the second function is “punch”. In this case, the apparatus setting values “two positions, one position” of the printer A and printer F do not include the instruction setting value “four positions” but include the alternative setting value “two positions”. The apparatus setting values “two holes, three holes” of the printer A include the instruction setting value “two holes”, and the apparatus setting value “no (punch)” of the printer F does not include the instruction setting value “two holes”. Therefore, the candidate rank of the printer A is higher than the candidate rank of the printer F.

Furthermore, in the examples of FIG. 4 to FIG. 7, a case is considered where the first printer 40 is the printer C, the second printer 40 is the printer D, the first function is “staple”, and the second function is “punch”. In this case, the apparatus setting value “no (staple)” of the printer C and the printer D does not include the instruction setting value “four positions”. The apparatus setting value “no (punch)” of the printer C does not include the instruction setting value “two holes”, and the apparatus setting values “two holes, four holes” of the printer D includes the instruction setting value “two holes”. Therefore, the candidate rank of the printer D is higher than the candidate rank of the printer C.

In the present exemplary embodiment, the processing for generating the candidate ranking in accordance with the second rule is performed based on the priority determined in advance for the plurality of setting items, as an example of generating the approximation ranking.

Additionally, in the present exemplary embodiment, in a case where the setting condition under which the first information processing apparatus is capable of processing satisfies the setting value of the first setting item, and the setting condition under which the second information processing apparatus is capable of processing satisfies the setting value of the first setting item, when the setting condition under which the first information processing apparatus is capable of processing satisfies the setting value of the second setting item at a rank of the priority next to the first setting item, and the setting condition under which the second information processing apparatus is capable of processing does not satisfy the setting value of the second setting item, the processing for generating the candidate ranking in accordance with the second rule is performed in a manner such that the approximation ranking of the first information processing apparatus is higher than the approximation ranking of the second information processing apparatus, as an example of generating the approximation ranking.

Further, in the present exemplary embodiment, in a case where the setting condition under which the first information processing apparatus is capable of processing does not satisfy the setting value of the first setting item, and the setting condition under which the second information processing apparatus is capable of processing does not satisfy the setting value of the first setting item, when the setting condition under which the first information processing apparatus is capable of processing satisfies the setting value of the second setting item at a rank of the priority next to the first setting item, and the setting condition under which the second information processing apparatus is capable of processing does not satisfy the setting value of the second setting item, the processing for generating the candidate ranking in accordance with the second rule is performed in a manner such that the approximation ranking of the first information processing apparatus is higher than the approximation ranking of the second information processing apparatus, as an example of generating the approximation ranking.

In addition, when the apparatus setting value that can be set in the printer 40 does not include the instruction setting value, the list information generation unit 36 generates the list information including the content of such a change to the instruction setting value that the apparatus setting value includes the instruction setting value. Here, the content of the change to the instruction setting value may indicate changing the instruction setting value to an alternative setting value for the instruction setting value. In addition, the alternative setting value used at this time may be selected from a plurality of alternative setting values based on the alternative ranking. For example, when there are the alternative setting value of the alternative rank “1” and the alternative setting value of the alternative rank “2”, the alternative setting value used at this time may be the alternative setting value of the alternative rank “1”.

In the examples of FIG. 4 to FIG. 7, for the function “staple”, the apparatus setting values “two positions, one position” of the printer A do not include the instruction setting value “four positions”, but include the alternative setting value “two positions” of the alternative rank “1” and the alternative setting value “one position” of the alternative rank “2” for the instruction setting value “four positions”. Therefore, the content of the change of the function “staple” of the printer A may be set to “four positions→two positions” using the alternative setting value at the higher alternative rank.

In the present exemplary embodiment, when the setting condition under which each information processing apparatus of one or more information processing apparatuses is capable of processing does not include the setting value, the list information including the content of such a change is used that the setting condition under which each information processing apparatus is capable of processing includes the setting value, as an example of the approximation information including the content of the change to the setting value. Further, in the present exemplary embodiment, this processing of the list information generation unit 36 is performed as an example of including the content of the change for changing the setting value to the alternative setting value in the approximation information. Moreover, in the present exemplary embodiment, this processing of the list information generation unit 36 is performed as an example of including the content of the change for changing the setting value to the alternative setting value based on the alternative ranking in the approximation information.

The print instruction storage unit 37 stores a print instruction including the instruction setting value and print data. Here, the instruction setting value may be the instruction setting value received by the reception unit 31, or may be the instruction setting value obtained by changing the instruction setting value received by the reception unit 31 according to the content of the change included in the list information generated by the list information generation unit 36.

The print instruction management unit 38 writes a print instruction including an instruction setting value and print data in the print instruction storage unit 37. However, after the user selects the printer 40 as the output destination, the print instruction management unit 38 changes the instruction setting value based on the content of the change corresponding to the selected printer 40 included in the list information generated by the list information generation unit 36, and writes the changed instruction setting value.

Further, the print instruction management unit 38 reads the print instruction including the instruction setting value and the print data from the print instruction storage unit 37. For example, when a user moves to the front of the printer 40 of the output destination and gives an output instruction of the print data, the print instruction management unit 38 reads the instruction setting value and the print data stored in the print instruction storage unit 37.

The transmission unit 39 transmits the list information of the printer 40 generated by the list information generation unit 36 to the terminal apparatus 10. Here, the list information of the printer 40 is information in which the printers 40 with the apparatus setting value close to the instruction setting value instructed by the user are arranged. Alternatively, in a case where there is no printer 40 that can perform output with the apparatus setting value matching the instruction setting value instructed by the user, the list information of the printer 40 may be information in which the printers 40 that can perform output with the apparatus setting value close to the instruction setting value instructed by the user are arranged. Further, as described above, the list information of the printer 40 may be information indicating how close the apparatus setting value of the printer 40 is to the instruction setting value instructed by the user. In the present exemplary embodiment, this processing of the transmission unit 39 is performed as an example of outputting an information processing apparatus that is capable of processing under the setting condition approximate to the setting value. Furthermore, in the present exemplary embodiment, in a case where there is no information processing apparatus that is capable of processing under the setting condition matching the setting value, this processing of the transmission unit 39 is performed as an example of outputting an information processing apparatus that is capable of processing under the setting condition approximate to the setting value. Further, in the present exemplary embodiment, this processing of the transmission unit 39 is performed as an example of further outputting the approximation information indicating how approximate the setting condition under which one or more information processing apparatuses are capable of processing is to the setting value.

In addition, when the user moves to the front of the printer 40 of the output destination and gives the output instruction of the print data, the transmission unit 39 transmits the instruction setting value and the print data read from the print instruction storage unit 37 by the print instruction management unit 38 to the printer 40.

### Operation of Cloud Server

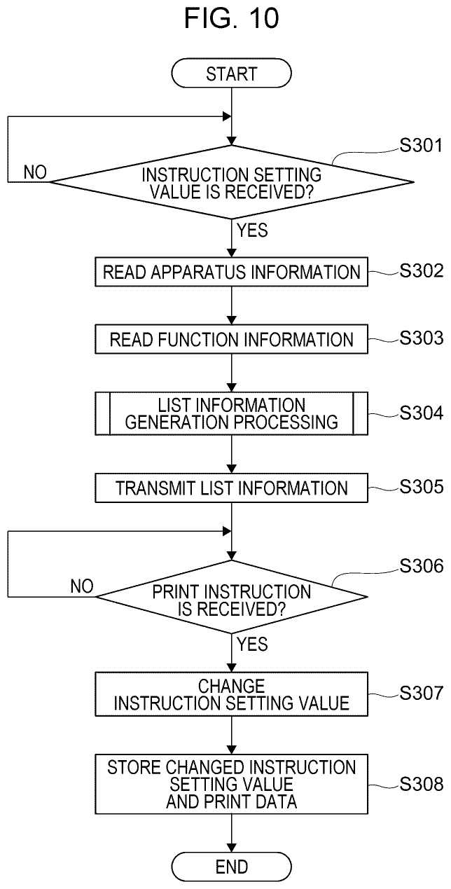

FIG. 10 is a flowchart illustrating an operation example of the cloud server 20 according to the present exemplary embodiment.

As illustrated, in the cloud server 20, first, it is determined whether or not the reception unit 31 has received an instruction setting value from the terminal apparatus 10 (step 301).

When it is not determined in step 301 that the instruction setting value has been received from the terminal apparatus 10, the reception unit 31 repeats step 301.

On the other hand, when it is determined in step 301 that the instruction setting value has been received from the terminal apparatus 10, the cloud server 20 performs processing for transmitting the list information of the printer 40 to the terminal apparatus 10. That is, first, the apparatus information management unit 33 reads apparatus information from the apparatus information storage unit 32 (step 302). Next, the function information management unit 35 reads function information from the function information storage unit 34 (step 303). Next, the list information generation unit 36 performs list information generation processing for generating list information of the printer 40 based on the instruction setting value received in step 301, the apparatus information read in step 302, and the function information read in step 303 (step 304). Here, the list information of the printer 40 is, for example, the information illustrated as the list information 121 in FIG. 7. Details of the list information generation processing will be described later. Thereafter, the transmission unit 39 transmits the list information of the printer 40 generated in step 304 to the terminal apparatus 10 (step 305).

Thus, the list information of the printer 40 is displayed on the display device 15 of the terminal apparatus 10. Then, the user selects the printer 40 as the output destination with reference to the list information. Therefore, the terminal apparatus 10 transmits a print instruction of print data including information on the selected printer 40 to the cloud server 20.

As such, in the cloud server 20, it is determined whether or not the reception unit 31 has received the print instruction from the terminal apparatus 10 (step 306).

When it is not determined in step 306 that the print instruction has been received from the terminal apparatus 10, the reception unit 31 repeats step 306.

On the other hand, when it is determined in step 306 that the print instruction has been received from the terminal apparatus 10, the cloud server 20 performs processing for storing the print instruction in order to output the print data in the printer 40. That is, first, the print instruction management unit 38 changes the instruction setting value received in step 301 based on the list information of the printer 40 generated in step 304 (step 307). Specifically, the print instruction management unit 38 changes the instruction setting value based on the content of the change corresponding to the selected printer 40 included in the print instruction received in step 306, of the content of the change included in the list information generated in step 304. Here, the content of the change is, for example, information shown as the content of the change in the list information 121 in FIG. 7. Thereafter, the print instruction management unit 38 stores the instruction setting value changed in step 307 and the print data to be output according to the print instruction received in step 306 in the print instruction storage unit 37 (step 308).

Thereafter, when the user gives an output instruction from the printer 40 of the output destination, although not illustrated, the cloud server 20 performs processing for transmitting the print data to the printer 40. That is, the reception unit 31 receives the output instruction from the printer 40 of the output destination, the print instruction management unit 38 reads the instruction setting value and the print data from the print instruction storage unit 37, and the transmission unit 39 transmits these data to the printer 40 of the output destination.

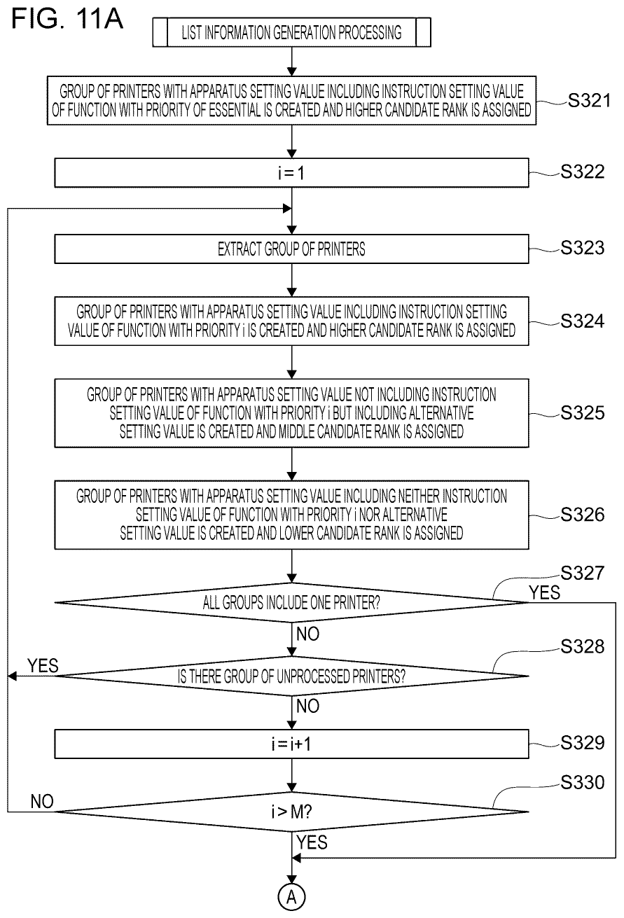

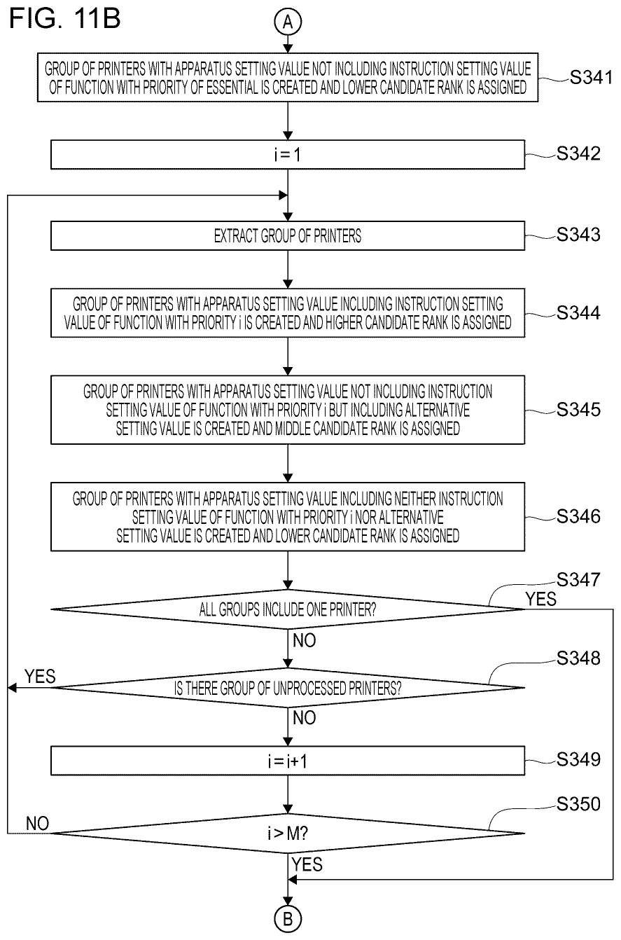

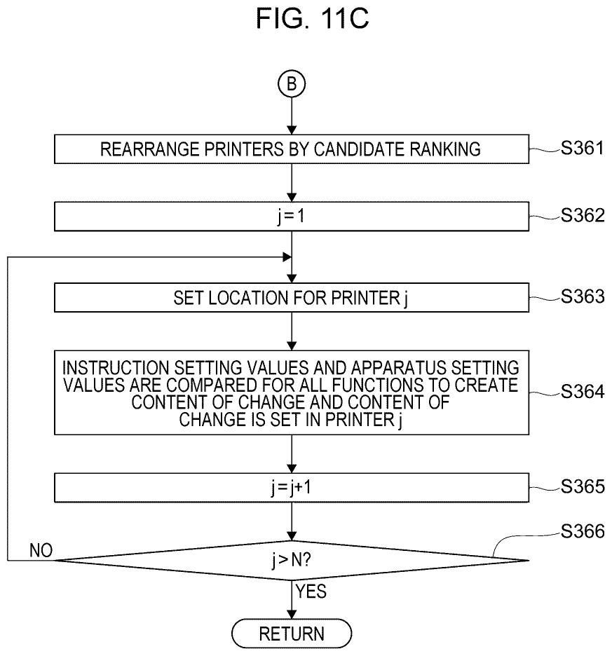

FIG. 11A to FIG. 11C are flowcharts illustrating an example of detailed content of the list information generation processing in FIG. 10.

First, as illustrated in FIG. 11A, the list information generation unit 36 creates a group of printers 40 with the apparatus setting value including the instruction setting value of the function the priority of which is “essential”, and assigns a higher candidate rank (step 321). Here, the apparatus setting value is acquired from the apparatus information read in step 302 in FIG. 10. Furthermore, the higher candidate ranks are ranks from 1 to the number of printers 40 included in the group created in this step. However, when no group is created, no candidate rank is assigned.

In the examples of FIG. 4 to FIG. 7, the instruction setting value of the function “color/monochrome” the priority of which is “essential” is “color”. Of the printers A to F, the printer 40 with the apparatus setting value including this instruction setting value is the printers A, C, D, and F. Therefore, the printers A, C, D, and F are assigned the candidate ranks “1” to “4”.

Next, the list information generation unit 36 sets an index i indicating the priority to 1 (step 322). Next, the list information generation unit 36 repeats the following processing until the index i reaches the number M of priorities.

That is, first, the list information generation unit 36 extracts the group of printers 40 (step 323). Here, the group of printers 40 to be extracted is the group of printers 40 created in step 321 in a case where i is 1, and is the group of printers 40 created in steps 324 to 326 in the processing at i−1 in a case where i is 2 or more.

In the examples of FIG. 4 to FIG. 7, when i is 1, the group of printers A, C, D, and F is extracted.

Further, in the case where i is 2, the group of printers A and F created in step 325 and the group of printers C and D created in step 326 are sequentially extracted.

Next, the list information generation unit 36 creates the group of printers 40 with the apparatus setting value including the instruction setting value of the function the priority of which is i from the group of printers 40 extracted in step 323, and assigns the higher candidate rank (step 324). Here, the apparatus setting value is acquired from the apparatus information read in step 302 in FIG. 10. In addition, the higher candidate rank is a rank from the number obtained by adding 1 to the candidate rank assigned most recently in the processing of the same i, up to the number obtained by adding the number of printers 40 included in the group created in this step to the candidate rank assigned most recently in the processing of the same i. However, when the candidate rank has not yet been assigned in the processing of the same i, the candidate rank assigned most recently in the processing of the same i is set to “0”.

In the examples of FIG. 4 to FIG. 7, in the case where i is 1, the instruction setting value of the function “staple” the priority of which is “1” is “four positions”. Of the printers A, C, D, and F, there is no printer 40 with the apparatus setting value including this instruction setting value. Therefore, none of the printers 40 are assigned the candidate rank.

Furthermore, in the case where i is 2, the instruction setting value of the function “punch” the priority of which is “2” is “two holes”. Of the printers A and F, the printer 40 with the apparatus setting value including this instruction setting value is the printer A, and the candidate rank has not yet been assigned yet in the processing when i is 2. Therefore, the printer A is assigned the candidate rank “1”. Of the printers C and D, the printer 40 with the apparatus setting value including this instruction setting value is the printer D, and the candidate rank “2” has been assigned most recently in step 326 in the processing when i is 2. Therefore, the printer D is assigned the candidate rank “3”.

Next, the list information generation unit 36 creates the group of printers 40 with the apparatus setting value not including the instruction setting value of the function the priority of which is i but including the alternative setting value from the group of printers 40 extracted in step 323, and assigns a middle candidate rank (step 325). Here, the apparatus setting value is acquired from the apparatus information read in step 302 in FIG. 10. In addition, as the alternative setting value, an alternative setting value at the highest alternative rank corresponding to the instruction setting value of the function the priority of which is i in the function information read in step 303 in FIG. 10 may be used. Furthermore, the middle candidate rank is a rank from the number obtained by adding 1 to the candidate rank assigned most recently in the processing of the same i, up to the number obtained by adding the number of printers 40 included in the group created in this step to the candidate rank assigned most recently in the processing of the same i. However, when the candidate rank has not yet been assigned in the processing of the same i, the candidate rank assigned most recently in the processing of the same i is set to “0”.

In the examples of FIG. 4 to FIG. 7, in the case where i is 1, the instruction setting value of the function “staple” the priority of which is “1” is “four positions”. Of the printers A, C, D, and F, the printer 40 with the apparatus setting value not including this instruction setting value but including the alternative setting value is the printers A and F, and the candidate rank has not been assigned in the processing when i is 1. Therefore, the printers A and F are assigned the candidate ranks “1” and “2”.

Furthermore, in the case where i is 2, the instruction setting value of the function “punch” the priority of which is “2” is “two holes”. Of the printers A and F, there is no printer 40 with the apparatus setting value not including this instruction setting value but including the alternative setting value. Therefore, none of the printers 40 are assigned the candidate rank. Of the printers C and D, there is no printer 40 with the apparatus setting value not including this instruction setting value but including the alternative setting value. Therefore, none of the printers 40 are assigned the candidate rank.

Next, the list information generation unit 36 creates the group of printers 40 with apparatus setting value including neither the instruction setting value of the function the priority of which is i nor the alternative setting value from the group of printers 40 extracted in step 323, and assigns a lower candidate rank (step 326). Here, the apparatus setting value is acquired from the apparatus information read in step 302 in FIG. 10. In addition, as the alternative setting value, all the alternative ranks corresponding to the instruction setting value of the function the priority of which is i in the function information read in step 303 in FIG. 10 may be used. Furthermore, the lower candidate rank is a rank from the number obtained by adding 1 to the candidate rank assigned most recently in the processing of the same i, up to the number obtained by adding the number of printers 40 included in the group created in this step to the candidate rank assigned most recently in the processing of the same i. However, when the candidate rank has not yet been assigned in the processing of the same i, the candidate rank assigned most recently in the processing of the same i is set to “0”.

In the examples of FIG. 4 to FIG. 7, in the case where i is 1, the instruction setting value of the function “staple” the priority of which is “1” is “four positions”. Of the printers A, C, D, and F, the printer 40 with the apparatus setting value including neither this instruction setting value nor the alternative setting value is the printers C and D, and the candidate rank “2” has been assigned most recently in step 325 in the processing when i is 1. Therefore, the printers C and D are assigned the candidate ranks “3” and “4”.

Furthermore, in the case where i is 2, the instruction setting value of the function “punch” the priority of which is “2” is “two holes”. Of the printers A and F, the printer 40 with the apparatus setting value including neither this instruction setting value nor the alternative setting value is the printer F, and the candidate rank “1” has been assigned most recently in step 324 in the processing when i is 2. Therefore, the printer F is assigned the candidate rank “2”. Of the printers C and D, the printer 40 with the apparatus setting value including neither this instruction setting value nor the alternative setting value is the printer C, and the candidate rank “3” has been assigned most recently in step 324 in the processing when i is 2. Therefore, the printer C is assigned the candidate rank “4”.

Next, the list information generation unit 36 determines whether or not all the groups include only one printer 40 (step 327).

When it is not determined in step 327 that all the groups include only one printer 40, the list information generation unit 36 determines whether or not there is a group of unprocessed printers 40 (step 328). Here, the group of unprocessed printers 40 is the group of printers 40 that is created in steps 324 to 326 in the processing at i−1 but is not extracted in step 323 in the processing at i.

When it is determined in step 328 that there is the group of unprocessed printers 40, the list information generation unit 36 returns the process to step 323.

On the other hand, when it is not determined in step 328 that there is the group of unprocessed printers 40, the list information generation unit 36 adds 1 to the index i indicating the priority (step 329). Next, the list information generation unit 36 determines whether or not the index i is greater than the number M of priorities (step 330).

When it is determined in step 330 that the index i is not greater than the number M of priorities, the list information generation unit 36 returns the process to step 323.

On the other hand, when it is determined in step 330 that the index i is greater than the number M of priorities, the list information generation unit 36 advances the process to step 341 in FIG. 11B.

Next, as illustrated in FIG. 11B, the list information generation unit 36 creates a group of printers 40 with the apparatus setting value not including the instruction setting value of the function the priority of which is “essential”, and assigns the lower candidate rank (step 341). Here, the apparatus setting value is acquired from the apparatus information read in step 302 in FIG. 10. In addition, the lower candidate rank is a rank from the number obtained by adding 1 to the lowest candidate rank assigned in FIG. 11A, up to the number obtained by adding the number of printers 40 included in the group created in this step to the lowest candidate rank assigned in FIG. 11A. However, when no group is created, no candidate rank is assigned.

In the examples of FIG. 4 to FIG. 7, the instruction setting value of the function “color/monochrome” the priority of which is “essential” is “color”. Of the printers A to F, the printer 40 with the apparatus setting value not including this instruction setting value is the printers B and E. Therefore, the printers B and E are assigned the candidate ranks “5” and “6”.

Next, the list information generation unit 36 sets the index i indicating the priority to 1 (step 342). Next, the list information generation unit 36 repeats the following processing until the index i reaches the number M of priorities.

That is, first, the list information generation unit 36 extracts the group of the printers 40 (step 343). Here, in the case where i is 1, the group of printers 40 to be extracted is the group of printers 40 created in step 341.

In the examples of FIG. 4 to FIG. 7, in the case where i is 1, the group of printers B and E is extracted.

Next, the list information generation unit 36 creates the group of printers 40 with the apparatus setting value including the instruction setting value of the function the priority of which is i from the group of printers 40 extracted in step 343, and assigns the higher candidate rank (step 344). Here, the apparatus setting value is acquired from the apparatus information read in step 302 in FIG. 10. In addition, the higher candidate rank is a rank from the number obtained by adding 1 to the candidate rank assigned most recently in the processing of the same i, up to the number obtained by adding the number of printers 40 included in the group created in this step to the candidate rank assigned most recently in the processing of the same i. However, in a case where the candidate rank has not yet been assigned in the processing of the same i, the candidate rank assigned most recently in the processing of the same i is set as the lowest candidate rank assigned in FIG. 11A.

In the examples of FIG. 4 to FIG. 7, in the case where i is 1, the instruction setting value of the function “staple” the priority of which is “1” is “four positions”. Of the printers B and E, the printer 40 with the apparatus setting value including this instruction setting value is the printer B, and the candidate rank has not yet been assigned in the processing when i is 1. Therefore, the printer B is assigned the candidate rank “5”.

Next, the list information generation unit 36 creates the group of printers 40 with the apparatus setting value not including the instruction setting value of the function the priority of which is i but including the alternative setting value from the group of printers 40 extracted in step 343, and assigns the middle candidate rank (step 345). Here, the apparatus setting value is acquired from the apparatus information read in step 302 in FIG. 10. In addition, as the alternative setting value, an alternative setting value at the highest alternative rank corresponding to the instruction setting value of the function the priority of which is i in the function information read in step 303 in FIG. 10 may be used. Furthermore, the middle candidate rank is a rank from the number obtained by adding 1 to the candidate rank assigned most recently in the processing of the same i, up to the number obtained by adding the number of printers 40 included in the group created in this step to the candidate rank assigned most recently in the processing of the same i. However, in a case where the candidate rank has not yet been assigned in the processing of the same i, the candidate rank assigned most recently in the processing of the same i is set as the lowest candidate rank assigned in FIG. 11A.

In the examples of FIG. 4 to FIG. 7, in the case where i is 1, the instruction setting value of the function “staple” the priority of which is “1” is “four positions”. Of the printer B and E, there is no printer 40 with the apparatus setting value not including this instruction setting value but including the alternative setting value. Therefore, none of the printers 40 are assigned the candidate rank.

Next, the list information generation unit 36 creates the group of printers 40 with the apparatus setting value including neither the instruction setting value of the function the priority of which is i nor the alternative setting value from the group of printers 40 extracted in step 343, and assigns the lower candidate rank (step 346). Here, the apparatus setting value is acquired from the apparatus information read in step 302 in FIG. 10. In addition, as the alternative setting value, all the alternative ranks corresponding to the instruction setting value of the function the priority of which is i in the function information read in step 303 in FIG. 10 may be used. Furthermore, the lower candidate rank is a rank from the number obtained by adding 1 to the candidate rank assigned most recently in the processing of the same i, up to the number obtained by adding the number of printers 40 included in the group created in this step to the candidate rank assigned most recently in the processing of the same i. However, in a case where the candidate rank has not yet been assigned in the processing of the same i, the candidate rank most recently assigned in the processing of the same i is set as the lowest candidate rank assigned in FIG. 11A.

In the examples of FIG. 4 to FIG. 7, in the case where i is 1, the instruction setting value of the function “staple” the priority of which is “1” is “four positions”. Of the printers B and E, the printer 40 with the apparatus setting value including neither this instruction setting value nor the alternative setting value is the printer E, and the candidate rank “5” has been assigned most recently in step 344 in the processing when i is 1. Therefore, the printer E is assigned the candidate rank “6”.

Next, the list information generation unit 36 determines whether or not all the groups include only one printer 40 (step 347).

When it is not determined in step 347 that all the groups include only one printer 40, the list information generation unit 36 determines whether or not there is the group of unprocessed printers 40 (step 348). Here, the group of unprocessed printers 40 is the group of printers 40 that is created in steps 344 to 346 in the processing at i−1 but is not extracted in step 343 in the processing at i.

When it is determined in step 348 that there is the group of unprocessed printers 40, the list information generation unit 36 returns the process to step 343.

On the other hand, when it is not determined in step 348 that there is the group of unprocessed printers 40, the list information generation unit 36 adds 1 to the index i indicating the priority (step 349). Next, the list information generation unit 36 determines whether or not the index i is greater than the number M of priorities (step 350).

When it is determined in step 350 that the index i is not greater than the number M of priorities, the list information generation unit 36 returns the process to step 343.

On the other hand, when it is determined in step 350 that the index i is greater than the number M of priorities, the list information generation unit 36 advances the process to step 361 in FIG. 11C.

Next, as illustrated in FIG. 11C, the list information generation unit 36 rearranges the plurality of printers 40 according to the candidate ranks assigned in FIG. 11A and FIG. 11B (step 361).

Next, the list information generation unit 36 sets an index j indicating the printer 40 to 1 (step 362). Then, the list information generation unit 36 repeats the following processing until the index j reaches the number N of printers 40.

That is, first, the list information generation unit 36 acquires the information on the location of the printer 40 of the index j (hereinafter, referred to as “printer j”) from the apparatus information read in step 302 in FIG. 10, and sets the location information in the printer j (step 363). Furthermore, the list information generation unit 36 acquires the apparatus setting value of the printer j from the apparatus information read in step 302 in FIG. 10, compares the instruction setting values and the apparatus setting values for all the functions to generate content of the change, and sets this content of the change in the printer j (step 364). Thereafter, the list information generation unit 36 adds 1 to the index j indicating the printer 40 (step 365). Then the list information generation unit 36 determines whether the index j is greater than the number N of printers 40 (step 366).

When it is determined in step 366 that the index j is not greater than the number N of printers 40, the list information generation unit 36 returns the process to step 363.

On the other hand, when it is determined in step 366 that the index j is greater than the number N of printers 40, the list information generation unit 36 returns the process to FIG. 10.

Note that although the main part of the operation of the printing system 1 is performed by the cloud server 20 in the present exemplary embodiment, a part of the operation of the printing system 1 may be performed by the terminal apparatus 10 or the printer 40.

### Processor

In the present exemplary embodiment, the processor refers to a processor in a broad sense, and includes general-purpose processors (for example, Central Processing Unit (CPU) and the like) and dedicated processors (for example, Graphics Processing Unit (GPU), Application Specific Integrated Circuit (ASIC), Field Programmable Gate Array (FPGA), programmable logic devices, and the like).

Further, the operation of the processor in the present exemplary embodiment may be performed not only by one processor but also by a plurality of processors existing at physically distant positions in cooperation with each other. In addition, the order of the operations of the processor is not limited to the order described in the present exemplary embodiment, and may be changed.

### Program

The processing performed by the cloud server 20 in the present exemplary embodiment is prepared as, for example, a program such as application software.

In this case, the program for realizing the present exemplary embodiment is regarded as a program for causing a computer to execute a function of acquiring a setting value of one or more setting items and a setting condition under which one or more information processing apparatuses are capable of processing, and a function of outputting an information processing apparatus that is capable of processing under a setting condition approximate to the setting value.

Note that the program for realizing the present exemplary embodiment can be provided not only by a communication unit but also by being stored in a recording medium such as a CD-ROM.

### APPENDIX

(((1)))

An information processing system comprising:
one or more processors configured to:
   acquire a setting value of one or more setting items and a setting condition under which one or more information processing apparatuses are capable of processing; and
   output an information processing apparatus that is capable of processing under a setting condition approximate to the setting value.
(((2)))

The information processing system according to (((1))), wherein the one or more processors are configured to, when there is no information processing apparatus that is capable of processing under a setting condition matching the setting value, output an information processing apparatus that is capable of processing under a setting condition approximate to the setting value.
(((3)))

The information processing system according to (((1))) or (((2))), wherein the one or more processors are configured to further output approximation information indicating how approximate a setting condition under which the one or more information processing apparatuses are capable of processing is to the setting value.
(((4)))

The information processing system according to (((3))), wherein the approximation information includes an approximation ranking that is a ranking of each information processing apparatus of the one or more information processing apparatuses and that is a ranking related to how approximate a setting condition under which each information processing apparatus is capable of processing is to the setting value.
(((5))

The information processing system according to (((4))), wherein the one or more processors are configured to:
when a setting condition under which a first information processing apparatus is capable of processing satisfies a setting value of a specific setting item and a setting condition under which a second information processing apparatus is capable of processing does not satisfy the setting value of the specific setting item,
generate the approximation ranking in a manner such that the approximation ranking of the first information processing apparatus is higher than the approximation ranking of the second information processing apparatus.
(((6)))

The information processing system according to (((4))), wherein the one or more processors are configured to generate the approximation ranking based on a priority determined in advance for a plurality of setting items.
(((7)))

The information processing system according to (((6))), wherein the one or more processors are configured to:
in a case where a setting condition under which a first information processing apparatus is capable of processing satisfies a setting value of a first setting item and a setting condition under which a second information processing apparatus is capable of processing satisfies the setting value of the first setting item,
when the setting condition under which the first information processing apparatus is capable of processing satisfies a setting value of a second setting item at a rank of the priority next to the first setting item and the setting condition under which the second information processing apparatus is capable of processing does not satisfy the setting value of the second setting item,
generate the approximation ranking in a manner such that the approximation ranking of the first information processing apparatus is higher than the approximation ranking of the second information processing apparatus.
(((8)))

The information processing system according to (((6))), wherein the one or more processors are configured to:
in a case where a setting condition under which a first information processing apparatus is capable of processing does not satisfy a setting value of a first setting item and a setting condition under which a second information processing apparatus is capable of processing does not satisfy the setting value of the first setting item,
when the setting condition under which the first information processing apparatus is capable of processing satisfies a setting value of a second setting item at a rank of the priority next to the first setting item and the setting condition under which the second information processing apparatus is capable of processing does not satisfy the setting value of the second setting item,
generate the approximation ranking in a manner such that the approximation ranking of the first information processing apparatus is higher than the approximation ranking of the second information processing apparatus.
(((9)))

The information processing system according to (((3))), wherein when a setting condition under which each information processing apparatus of the one or more information processing apparatuses is capable of processing does not include the setting value, the approximation information includes content of a change for the setting value to make the setting condition under which each information processing apparatus is capable of processing include the setting value.
(((10)))

The information processing system according to (((9))), wherein the one or more processors are configured to:
acquire an alternative setting value determined in advance for the setting value; and
include the content of the change for changing the setting value to the alternative setting value in the approximation information.
(((11)))

The information processing system according to (((10))), wherein the one or more processors are configured to:
further acquire an alternative ranking of the alternative setting value determined in advance for the setting value; and
include the content of the change for changing the setting value to the alternative setting value based on the alternative ranking in the approximation information.
(((12)))

An information processing method comprising:
acquiring, by a computer, a setting value of one or more setting items and a setting condition under which one or more information processing apparatuses are capable of processing; and
outputting, by the computer, an information processing apparatus that is capable of processing under a setting condition approximate to the setting value.
(((13)))

A program causing a computer to execute a process comprising:
acquiring a setting value of one or more setting items and a setting condition under which one or more information processing apparatuses are capable of processing; and
outputting an information processing apparatus that is capable of processing under a setting condition approximate to the setting value.

What is claimed is:

1. An information processing system comprising:
one or more processors configured to:
acquire a setting value of one or more setting items and a setting condition under which one or more information processing apparatuses are capable of processing; and
output an information processing apparatus that is capable of processing under a setting condition approximate to the setting value.

2. The information processing system according to claim 1, wherein the one or more processors are configured to, when there is no information processing apparatus that is capable of processing under a setting condition matching the setting value, output an information processing apparatus that is capable of processing under a setting condition approximate to the setting value.

3. The information processing system according to claim 1, wherein the one or more processors are configured to further output approximation information indicating how approximate a setting condition under which the one or more information processing apparatuses are capable of processing is to the setting value.

4. The information processing system according to claim 2, wherein the one or more processors are configured to further output approximation information indicating how approximate a setting condition under which the one or more information processing apparatuses are capable of processing is to the setting value.

5. The information processing system according to claim 3, wherein the approximation information includes an approximation ranking that is a ranking of each information processing apparatus of the one or more information processing apparatuses and that is a ranking related to how approximate a setting condition under which each information processing apparatus is capable of processing is to the setting value.

6. The information processing system according to claim 4, wherein the approximation information includes an approximation ranking that is a ranking of each information processing apparatus of the one or more information processing apparatuses and that is a ranking related to how approximate a setting condition under which each information processing apparatus is capable of processing is to the setting value.

7. The information processing system according to claim 5, wherein the one or more processors are configured to:
when a setting condition under which a first information processing apparatus is capable of processing satisfies a setting value of a specific setting item and a setting condition under which a second information processing apparatus is capable of processing does not satisfy the setting value of the specific setting item,
generate the approximation ranking in a manner such that the approximation ranking of the first information processing apparatus is higher than the approximation ranking of the second information processing apparatus.

8. The information processing system according to claim 6, wherein the one or more processors are configured to:
when a setting condition under which a first information processing apparatus is capable of processing satisfies a setting value of a specific setting item and a setting condition under which a second information processing apparatus is capable of processing does not satisfy the setting value of the specific setting item,
generate the approximation ranking in a manner such that the approximation ranking of the first information processing apparatus is higher than the approximation ranking of the second information processing apparatus.

9. The information processing system according to claim 7, wherein the one or more processors are configured to generate the approximation ranking based on a priority determined in advance for a plurality of setting items.

10. The information processing system according to claim 8, wherein the one or more processors are configured to generate the approximation ranking based on a priority determined in advance for a plurality of setting items.

11. The information processing system according to claim 9, wherein the one or more processors are configured to:
in a case where a setting condition under which a first information processing apparatus is capable of processing satisfies a setting value of a first setting item and a setting condition under which a second information processing apparatus is capable of processing satisfies the setting value of the first setting item,
when the setting condition under which the first information processing apparatus is capable of processing satisfies a setting value of a second setting item at a rank of the priority next to the first setting item and the setting condition under which the second information processing apparatus is capable of processing does not satisfy the setting value of the second setting item,
generate the approximation ranking in a manner such that the approximation ranking of the first information processing apparatus is higher than the approximation ranking of the second information processing apparatus.

12. The information processing system according to claim 10, wherein the one or more processors are configured to:
in a case where a setting condition under which a first information processing apparatus is capable of processing satisfies a setting value of a first setting item and a setting condition under which a second information processing apparatus is capable of processing satisfies the setting value of the first setting item,
when the setting condition under which the first information processing apparatus is capable of processing satisfies a setting value of a second setting item at a rank of the priority next to the first setting item and the setting condition under which the second information processing apparatus is capable of processing does not satisfy the setting value of the second setting item,
generate the approximation ranking in a manner such that the approximation ranking of the first information processing apparatus is higher than the approximation ranking of the second information processing apparatus.

13. The information processing system according to claim 9, wherein the one or more processors are configured to:
in a case where a setting condition under which a first information processing apparatus is capable of processing does not satisfy a setting value of a first setting item and a setting condition under which a second information processing apparatus is capable of processing does not satisfy the setting value of the first setting item,
when the setting condition under which the first information processing apparatus is capable of processing satisfies a setting value of a second setting item at a rank of the priority next to the first setting item and the setting condition under which the second information processing apparatus is capable of processing does not satisfy the setting value of the second setting item,
generate the approximation ranking in a manner such that the approximation ranking of the first information processing apparatus is higher than the approximation ranking of the second information processing apparatus.

14. The information processing system according to claim 10, wherein the one or more processors are configured to:
in a case where a setting condition under which a first information processing apparatus is capable of processing does not satisfy a setting value of a first setting item and a setting condition under which a second information processing apparatus is capable of processing does not satisfy the setting value of the first setting item,
when the setting condition under which the first information processing apparatus is capable of processing satisfies a setting value of a second setting item at a rank of the priority next to the first setting item and the setting condition under which the second information processing apparatus is capable of processing does not satisfy the setting value of the second setting item,
generate the approximation ranking in a manner such that the approximation ranking of the first information processing apparatus is higher than the approximation ranking of the second information processing apparatus.

15. The information processing system according to claim 3, wherein when a setting condition under which each information processing apparatus of the one or more information processing apparatuses is capable of processing does not include the setting value, the approximation information includes content of a change for the setting value to make the setting condition under which each information processing apparatus is capable of processing include the setting value.

16. The information processing system according to claim 4, wherein when a setting condition under which each information processing apparatus of the one or more information processing apparatuses is capable of processing does not include the setting value, the approximation information includes content of a change for the setting value to make the setting condition under which each information processing apparatus is capable of processing include the setting value.

17. The information processing system according to claim 15, wherein the one or more processors are configured to:
acquire an alternative setting value determined in advance for the setting value; and
include the content of the change for changing the setting value to the alternative setting value in the approximation information.

18. The information processing system according to claim 17, wherein the one or more processors are configured to:
further acquire an alternative ranking of the alternative setting value determined in advance for the setting value; and
include the content of the change for changing the setting value to the alternative setting value based on the alternative ranking in the approximation information.

19. An information processing method comprising:
acquiring, by a computer, a setting value of one or more setting items and a setting condition under which one or more information processing apparatuses are capable of processing; and
outputting, by the computer, an information processing apparatus that is capable of processing under a setting condition approximate to the setting value.

20. A non-transitory computer readable medium storing a program causing a computer to execute a process comprising:
acquiring a setting value of one or more setting items and a setting condition under which one or more information processing apparatuses are capable of processing; and
outputting an information processing apparatus that is capable of processing under a setting condition approximate to the setting value.
